(19) United States
(12) Patent Application Publication
(10) Pub. No.: US 2025/0192371 A1
(43) Pub. Date: Jun. 12, 2025

(54) SECONDARY BATTERY

(71) Applicant: Samsung SDI Co., Ltd., Yongin-si (KR)

(72) Inventors: Su Bin BAE, Yongin-si (KR); Sang Hun KIM, Yongin-si (KR); Hyun Kyu KIM, Yongin-si (KR)

(21) Appl. No.: 18/642,530

(22) Filed: Apr. 22, 2024

(30) Foreign Application Priority Data
Dec. 6, 2023 (KR) 10-2023-0175172

(51) Int. Cl. H01M 50/474; H01M 50/103; H01M 50/486; H01M 50/491

(52) U.S. Cl. CPC H01M 50/474; H01M 50/103; H01M 50/486; H01M 50/491

(57) ABSTRACT

A secondary battery includes: an electrode assembly including a first electrode plate, a second electrode plate, and a separator; a support structure fixed to a lower end of the electrode assembly; a case accommodating the electrode assembly; and a cap assembly coupled to an open side of the case. The support structure is in contact with a lower bottom surface of the case opposite to the open side of the case.

### CROSS-REFERENCE TO RELATED APPLICATION

The present application claims priority to and the benefit of Korean Patent Application No. 10-2023-0175172, filed on Dec. 6, 2023, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Secondary batteries are designed to be chargeable and dischargeable batteries, different from primary batteries that are not designed to be chargeable. Low-capacity secondary batteries are used in portable, small electronic devices, such as smart phones, feature phones, notebook computers, digital cameras, and camcorders, while large-capacity secondary batteries are widely used for a power source and power storage for driving a motor, such as in hybrid vehicles, electric vehicles, and the like.

Secondary batteries are manufactured in various shapes, such as a cylindrical shape, a prismatic shape, and a pouch shape. An electrode assembly, which is provided by interposing a separator between positive and negative electrode plates, and an electrolyte are accommodated and installed in a case, and a cap plate is installed on the case.

The above-described information provides the background of the present disclosure and is for improving understanding of the background of the present disclosure and, thus, may include information that does not constitute the related (or prior) art.

### SUMMARY

Embodiments of the present disclosure provide a secondary battery in which a high-capacity electrode assembly stack is fixed and supported inside a case to improve stability and productivity.

However, aspects and features of the present disclosure are not limited to those described above, and other aspects and features not mentioned will be clearly understood by those skilled in the art from the description of the present disclosure described below.

According to an embodiment of the present disclosure, a secondary battery includes: an electrode assembly including a first electrode plate, a second electrode plate, and a separator; a support structure fixed to a lower end of the electrode assembly; a case accommodating the electrode assembly; and a cap assembly coupled to an open side of the case. The support structure contacts a lower bottom surface of the case.

The electrode assembly may include repeating stack of the first electrode plate and the second electrode plate with the separator therebetween.

The support structure may have a planar shape corresponding to that of the lower end of the electrode assembly and may have a height corresponding to a gap between the lower end of the electrode assembly and the lower bottom surface of the case.

The support structure may include a plastic material.

The plastic material may be engineering plastic.

The support structure may have pores, and each of the pores may have a diameter of about 10 mm or less.

The support structure may include a resin-based binder on at least a portion of a top surface of the support structure and adhered to the lower end of the electrode assembly.

### BRIEF DESCRIPTION OF THE DRAWINGS

The following drawings attached hereto illustrate embodiments of the present disclosure and are intended to provide a further understood the technical spirit of the present disclosure along with the detailed description of the present disclosure. Thus, the present disclosure should not be construed as being limited to the embodiments as illustrated in the drawings. In the drawings:

FIG. 1 is a perspective view of a secondary battery according to an embodiment;

FIG. 2 is an exploded perspective view the secondary battery shown in FIG. 1;

FIGS. 3A and 3B are schematic diagrams of a case, an electrode assembly, and a support structure of the secondary battery shown in FIG. 1; and

FIG. 4 includes cross-sectional and plan views of the support structure applied to the secondary battery according to an embodiment.

### DETAILED DESCRIPTION

Hereinafter, embodiments of the present disclosure will be described in more detail with reference to the accompanying drawings. The terms used in the following description and claims are not limited to their dictionary meanings but are merely used to enable a clear and consistent understanding of the present disclosure. Accordingly, it should be apparent to those skilled in the art that the following description of embodiments of the present disclosure is provided for illustration purposes and not for the purpose of limiting the present disclosure. The present disclosure is defined by the appended claims and their equivalents. Thus, because the embodiments described in this specification and the configurations shown in the drawings are only some example embodiments of the present disclosure and do not represent all of the technical ideas of the present disclosure, it should be understood that there may be various equivalents and modifications that can be substituted for them at the time of this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The reference to two objects of comparison being “the same” means “substantially the same”. Therefore, “the same” or “substantially the same” may include a deviation that is considered as a low level in the art, for example, a deviation of less than 5%. In addition, uniformity of a parameter at a certain area may mean uniformity from an average perspective.

In some embodiments of the cylindrical/prismatic/pouch-type battery according to an embodiment of the present disclosure, one of the prismatic/pouch/cylindrical batteries is selected, and the selected battery is described as having a general structure, and for commonly applied technologies, may be applicable to the general structure of the outers of prismatic/pouch/cylindrical cells.

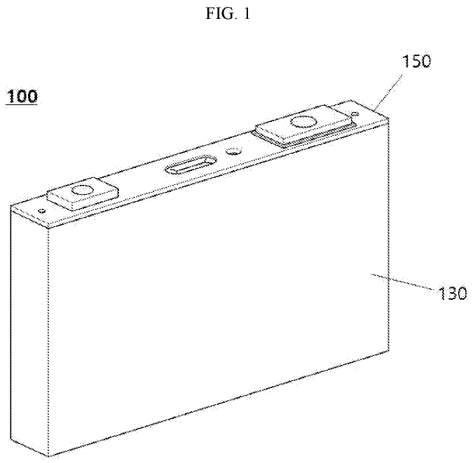

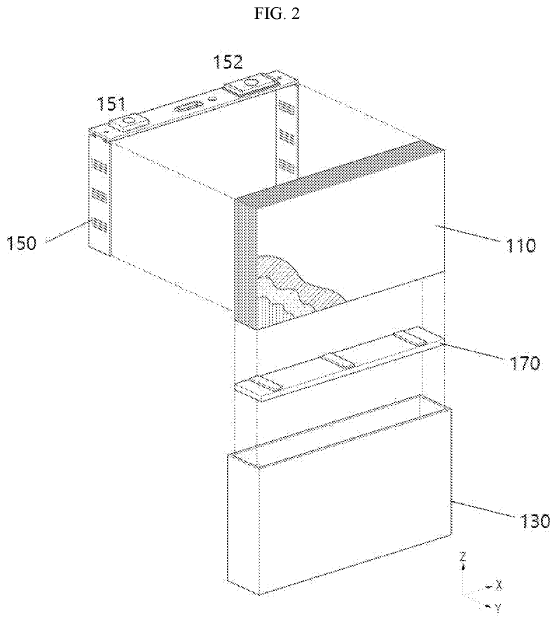

As illustrated in FIGS. 1 and 2, a secondary battery 100, according to an embodiment, may include an electrode assembly 110, a case 130, and a cap plate 150. A cap assembly may include the cap plate 150 and electrode terminals 151 and 152 mounted thereon.

The electrode assembly 110 may be provided by stacking a first electrode plate, a separator, and a second electrode plate, each of which is a thin plate or film. In some embodiments, the electrode assembly 110 is manufactured by repeatedly stacking the first electrode plate and the second electrode plate with the separator therebetween.

In the stacked electrode assembly 110, the separator may not be in complete contact with a positive electrode plate (e.g., the first electrode plate) and a negative electrode plate (e.g., the second electrode plate), thereby causing short circuit. To prevent this, the separator may be stacked in a state of being adhered with the positive electrode plate. In some embodiments, the negative electrode plate may be disposed above the positive electrode plate on which the separator is adhered to each of both surfaces thereof, and the positive electrode plate on which the separator is adhered to each of both surfaces thereof may be disposed above the negative electrode plate. Then, the negative electrode plate may be disposed above the positive electrode, and the positive electrode plate on which the separator is adhered to a bottoms surface thereof may be disposed above the negative electrode plate. As a result, the electrode assembly 110 may have a structure in which the positive electrode plate, the separator, and the negative electrode plate are sequentially stacked.

In some embodiments, the electrode assembly 110 may be stacked so that one or more electrode assemblies 110 are adjacent to each other and accommodated together in the case 130. The number of electrode assemblies 110 is not limited according to the present disclosure. In some embodiments, the first electrode plate of the electrode assembly 110 may act as a negative electrode, and the second electrode plate may act as a positive electrode. In some embodiments, the first electrode plate may act as a negative electrode, and the second electrode plate may act as a positive electrode.

The first electrode plate may be formed by applying a first electrode active material, such as graphite or carbon, to a first electrode current collector plate made of a metal foil, such as copper, a copper alloy, nickel, or a nickel alloy. The first electrode plate may include a first electrode tab (e.g., a first non-coating portion) that is not coated with the first electrode active material. The first electrode tab may provide a path for a current flow between the first electrode plate and a first current collector. In some embodiments, the first electrode tab may be provided by being cut in advance to protrude to one side when the first electrode plate is manufactured and may protrude more to one side than (e.g., may protrude beyond) a separator without being separately cut.

The second electrode plate may be provided by applying a second electrode active material, such as transition metal oxide, to a second electrode current collector plate made of a metal foil, such as aluminum or an aluminum alloy. The second electrode plate may include a second electrode tab (e.g., a second non-coating portion) that is not coated with the second electrode active material. The second electrode tab may be a passage through which current flows between the second electrode plate and a second current collector. In some embodiments, the second electrode tab may be provided by being cut in advance to protrude to the other side when the second electrode plate is manufactured and may protrude more to the other side than (e.g., may protrude beyond) the separator without being separately cut.

In some embodiments, the first electrode tab may be disposed on a side surface at a left end of the electrode assembly 110, and the second electrode tab may be disposed on a side surface at a right end of the electrode assembly 110 or disposed on one surface in the same direction. The left and right sides are referred to herein for convenience of explanation based on the secondary battery 100 as it is illustrated in FIG. 1, but the position of the secondary battery 100 may be changed by being rotated left and right or up and down.

A first electrode tab of the first electrode plate and a second electrode tab of the second electrode plate may be disposed on both ends of the electrode assembly 110 as described above, respectively. In some embodiments, the electrode assembly 110 may be accommodated in the case 130 together with the electrolyte. In some embodiments, in the electrode assembly 110, the first current collector and the second current collector may be welded and connected to the first electrode tab of the first electrode plate and the second electrode tab of the second electrode plate, which are exposed to both the sides, respectively.

The case 130 may accommodate the electrode assembly 110. For example, the case 130 may have a substantially rectangular parallelepiped shape defining a space for accommodating the electrode assembly 110 and the electrolyte therein, and an opening connecting external and internal spaces to each other is defined in one surface of the rectangular parallelepiped. The opening may allow the electrode assembly 110 to be inserted into the case 130.

In some embodiments, the case 130 may be made of a metal, such as aluminum, aluminum alloy, or nickel-plated steel, or a laminated film or plastic, such as in the case of a pouch type secondary battery.

The cap plate 150 may be installed in (or on or over) the opening in the case 130 to seal the opening in the case 130. For example, the case 130 and the cap plate 150 may be made of aluminum and welded to each other.

In some embodiments, the cap plate 150 may have a terminal hole (e.g., a terminal opening) and an electrolyte injection port. The electrolyte injection port may allow the electrolyte to be injected into the case 130 after coupling and welding the cap plate 150 to the case 130.

Negative and positive terminals 151 and 152 may be electrically and mechanically connected to the electrode assembly 110 and installed in (e.g., may protrude through) the terminal holes (e.g., terminal openings) in the cap plate 150. In some embodiments, the negative and positive terminals 151 and 152 may be electrically connected to the negative and positive terminals of the electrode assembly 110, respectively. In some embodiments, the electrode assembly 110 may be withdrawn to the outside of the case 130 through the negative and positive terminals 151 and 152.

As illustrated in FIGS. 2 to 4, a support structure 170 may be disposed and fixed on a lower end of the electrode assembly 110. When the electrode assembly 110 is inserted into the case 130, the support structure 170 may be supported to be in contact with a lower bottom surface of the case 130. In some embodiments, when the electrode assembly 110 is accommodated in the case 130, a clearance may be provided between the lower end of the electrode assembly 110 and the bottom surface of the case 130, and thus, the support structure 170 may be disposed in the clearance space to fill the empty space, thereby fixing the electrode assembly 110 inside the case 130 to prevent or reduce movement of the electrode assembly 110 when the secondary battery 100 is shaken and reducing vibration in a height direction.

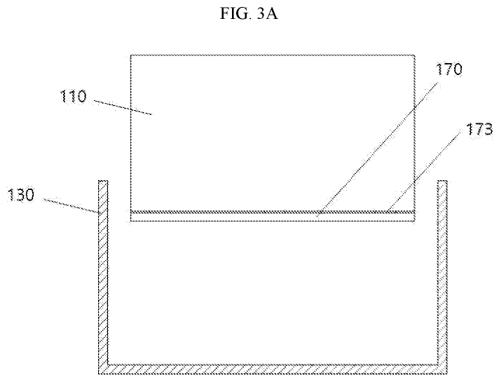

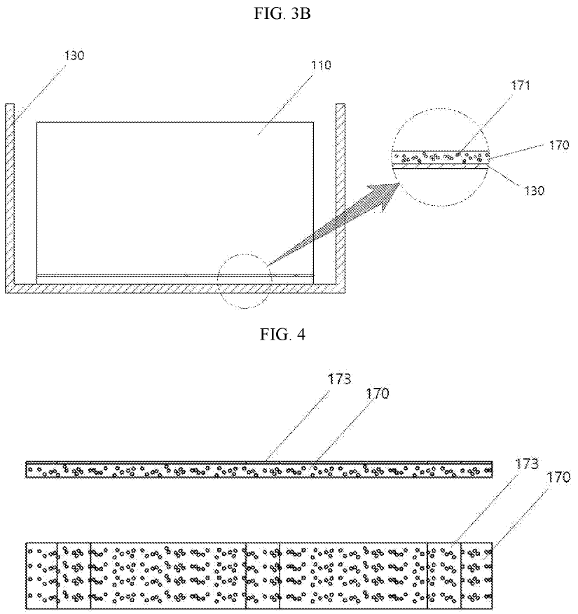

FIG. 2 is an exploded perspective view of the secondary battery 100 shown in FIG. 1, FIGS. 3A and 3B are schematic diagrams of the case, the electrode assembly, and the support structure of the secondary battery 100 shown in FIG. 1, and FIG. 4 includes cross-sectional and plan views of the support structure applied to the secondary battery according to an embodiment. The support structure 170 will be described, in more detail, with reference to the drawings.

The support structure 170 may have a planar shape corresponding to the lower end of the electrode assembly 110 and may have a height corresponding to a gap between the lower end of the electrode assembly 110 and the lower bottom surface of the case 130. The support structure 170, according to embodiments of the present disclosure, may be configured to prevent the cap assembly from being bent when a high-capacity and high-weight electrode assembly stack is accommodated in the case 130 and may have a planar shape corresponding to the lower end of the electrode assembly 110 to uniformly support the electrode assembly 110 upwardly. Therefore, the electrode assembly 110 may be stably supported. In some embodiments, to reduce or minimize vibrations between the electrode assembly 110 and the case 130, the gap between the electrode assembly 110 and the case 130 may be filled by the support structure 170.

The support structure 170 may be made of a high-performance plastic material, for example, engineering plastic. Engineering plastic may be high-performance plastic that can replace (or be used in place of) a metal and may be characterized by excellent strength, impact resistance, abrasion resistance, heat resistance, cold resistance, and chemical resistance. In some embodiments, engineering plastic may have electrical insulating properties to maintain the insulation between the electrode assembly 110 and the case 130.

In some embodiments, engineering plastics have excellent elasticity. According to some embodiments of the present disclosure, the support structure 170 may be made of engineering plastic to provide the elasticity, and thus, if an impact or vibration occurs between the electrode assembly 110 and the case 130, the support structure 170 may buffer the two components.

The engineering plastic may be polyamide (PA), polycarbonate (PC), polyethylene (PE), polypropylene (PP), polyimide (PI), polystyrene (PS), etc.

The support structure 170 may be a porous component and may have a plurality of pores 171 inside and in (or on) a surface thereof. Because the support structure 170 is disposed in the inner space of the case 130, the support structure 170 may be exposed to the electrolyte. As a result, when the support structure 170 has the pores 171, the electrolyte may be impregnated into the pores 171. In some embodiments, as described above, the support structure 170 may have elasticity due to the characteristics of the material thereof. When the support structure 170 has the pores 171, the support structure 170 may be more elastically deformed by external pressure to more effectively buffer the internal components. According to some embodiments of the present disclosure, each pore 171 may have a diameter of about 10 mm or less, and the porosity of the support structure 170 may be about 70% or more.

A resin-based binder 173 may be applied to at least one place (or one area) on a top surface of the support structure 170 and may be bonded to the lower end of the electrode assembly 110. The resin-based binder 173 may be, for example, a silicone resin or an acrylic resin. Silicone-based or acrylic-based resins may have excellent adhesive properties. As illustrated in FIGS. 2 and 3A, the support structure 170 may first be attached to the lower end of the electrode assembly stack, and the electrode assembly 110 with the support structure 170 attached thereto may be inserted into the case 130 and seated on the lower bottom surface of the case 130. The resin-based binder 173 may be applied to the top surface of the support structure 170 to improve adhesion to the electrode assembly 110. As illustrated in the drawings, the resin-based binder 173 may be applied, for example, at three places at equal intervals, but the present disclosure is not limited thereto.

In the context of electric vehicles, improving driving range is desirable, and for this purpose, demands for high-capacity secondary batteries are increasing. However, one limitation in manufacturing high-capacity batteries is bending of the cap assembly (e.g., bending of the cap plate 150) due to the high load on the electrode assembly. The bending of the cap assembly causes welding failure between the case 130 and the cap plate 150.

According to embodiment of the present disclosure, the support structure 170 may be disposed below the high-capacity electrode assembly 110 (also referred to as the stack) to fill a space between the case 130 and the electrode assembly 110. When the stack is disposed and fixed inside the case 130, movement or vibration of the stack may be suppressed, the stability is improved, and the cap assembly (e.g., the cap plate 150) may not be bent due to the fixed support of the stack, and thus, the welding failure between the case 130 and the cap assembly may be avoided. Furthermore, the stack alignment may be improved by the adhesion between the support structure and the stack with the resin-based binder.

According to embodiments of the present disclosure, the electrode assembly stack may be fixed inside the case to suppress movement of the stack and to avoid a welding failure between the case and the cap assembly, thereby improving the stability and the productivity.

However, aspects and features of the present disclosure are not limited to the above-described aspects and features, and other aspects and features not mentioned herein can be clearly understood by those skilled in the art from the description of the present disclosure and the following claims.

Although embodiments have been disclosed herein, and specific terms employed, they are used and are to be interpreted in a generic and descriptive sense and not for purpose of limitation. Accordingly, it will be understood by those of ordinary skill in the art that various changes in form and details may be made without departing from the spirit and scope of the present disclosure as set forth in the following claims and their equivalents.

What is claimed is:

1. A secondary battery comprising:
an electrode assembly comprising a first electrode plate, a second electrode plate, and a separator;
a support structure fixed to a lower end of the electrode assembly;
a case accommodating the electrode assembly; and
a cap assembly coupled to an open side of the case,
wherein the support structure is in contact with a lower bottom surface of the case opposite to the open side of the case.

2. The secondary battery as claimed in claim 1, wherein the electrode assembly comprises a repeating stack of the first electrode plate and the second electrode plate with the separator therebetween.

3. The secondary battery as claimed in claim 1, wherein the support structure has a planar shape corresponding to that of the lower end of the electrode assembly and has a height corresponding to a gap between the lower end of the electrode assembly and the lower bottom surface of the case.

4. The secondary battery as claimed in claim 1, wherein the support structure comprises a plastic material.

5. The secondary battery as claimed in claim 4, wherein the plastic material is engineering plastic.

6. The secondary battery as claimed in claim 1, wherein the support structure has pores, and
Wherein each of the pores has a diameter of 10 mm or less.

7. The secondary battery as claimed in claim 1, wherein the support structure comprises a resin-based binder on at least a portion of a top surface of the support structure and adhered to the lower end of the electrode assembly.
